(19) United States
(12) Patent Application Publication
(10) Pub. No.: US 2021/0016773 A1
(43) Pub. Date: Jan. 21, 2021

(54) Vehicle Control Apparatus, Vehicle Control Method, and Preceding Vehicle Following System

(71) Applicant: Hitachi Automotive Systems, Ltd., Hitachinaka-shi, Ibaraki (JP)

(72) Inventors: Hiroki SUGAWARA, Sagamihara-shi, Kanagawa (JP); Kentaro UENO, Atsugi-shi, Kanagawa (JP); Hiroshi ITO, Isehara-shi, Kanagawa (JP)

(21) Appl. No.: 16/979,769

(22) PCT Filed: Jan. 21, 2019
(86) PCT No.: PCT/JP2019/001596

§ 371 Date: Sep. 10, 2020

(30) Foreign Application Priority Data
Mar. 14, 2018 (JP) 2018-046239

(51) Int. Cl. B60W 30/165; B60W 30/16; B60W 40/107; B60K 31/00; B60W 50/08

(52) U.S. Cl. CPC B60W 30/165; B60W 30/162; B60W 40/107; B60W 2554/4041; B60W 50/082; B60W 2556/65; B60W 2520/105; B60K 31/00

(57) ABSTRACT

The present invention provides a vehicle control apparatus, a vehicle control method, and an preceding vehicle following system that allow a following vehicle to run while following behind a preceding vehicle even when a constraint is imposed on the following vehicle. A vehicle control apparatus is configured to be mounted on a preceding vehicle in a preceding vehicle following system that performs follow control by non-mechanically connecting the preceding vehicle and a following vehicle. The vehicle control apparatus is configured to output an instruction for restricting a motion state of the preceding vehicle based on input information regarding a vehicle performance of the following vehicle.

### TECHNICAL FIELD

The present invention relates to a preceding vehicle following system that allows a following vehicle to run while following behind a preceding vehicle.

### BACKGROUND ART

For example, there is PTL 1 as the background technique in the technical field relating to autonomous running control of a following vehicle that runs while following behind a preceding vehicle by being electronically connected to the preceding vehicle. PTL 1 discloses that the following vehicle receives information indicating a running state such as a vehicle speed and an acceleration, information indicating an operation amount such as a throttle position, a steering angle, and a brake operation amount, and information indicating the vehicle specifications such as a vehicle weight and an engine output characteristic with respect to the preceding vehicle, thereby allowing the follow control to be performed based on a similar operation to an operation provided to the preceding vehicle without waiting for a change in the running state that is a result of the control on the preceding vehicle.

### CITATION LIST

### Patent Literature

[PTL 1] Japanese Patent Application Public Disclosure No. H5-170008

### SUMMARY OF INVENTION

### Technical Problem

However, PTL 1 fails to take into consideration such a situation that a motion state of the following vehicle is subjected to a constraint imposed so as to make it impossible for the following vehicle to follow behind the preceding vehicle, such as when the following vehicle slips and when there is a difference in performance between the preceding vehicle and the following vehicle.

### Solution to Problem

In consideration of the above-described problem, one of objects of the present invention is to provide a vehicle control apparatus, a vehicle control method, and a preceding vehicle following system that allow the following vehicle to run while following behind the preceding vehicle even when the constraint is imposed on the following vehicle.

One aspect of the present invention is a vehicle control apparatus configured to be mounted on a preceding vehicle in a preceding vehicle following system that performs follow control by non-mechanically connecting the preceding vehicle and a following vehicle. The vehicle control apparatus is configured to output an instruction for restricting a motion state of the preceding vehicle based on input information regarding a vehicle performance of the following vehicle.

According to the one aspect of the present invention, it is possible to provide the vehicle control apparatus, the vehicle control method, and the preceding vehicle following system that allow the following vehicle to run while following behind the preceding vehicle even when the constraint is imposed on the following vehicle.

### BRIEF DESCRIPTION OF DRAWINGS

FIG. 1 is a block diagram illustrating a configuration of an preceding vehicle following system that performs control of causing a preceding vehicle to ease a brake when a following vehicle slips while being braked according to a first embodiment.

FIG. 2 illustrates an exemplary modification of FIG. 1.

FIG. 3 are timing charts of the preceding vehicle following system that performs the control of causing the preceding vehicle to ease the brake when the following vehicle slips while being braked according to the first embodiment.

FIG. 4 is a block diagram illustrating a configuration of the preceding vehicle following system that performs control of causing the preceding vehicle to ease an accelerator when the following vehicle slips while being driven according to the first embodiment.

FIG. 5 illustrates an exemplary modification of FIG. 4.

FIG. 6 are timing charts of the preceding vehicle following system that performs the control of causing the preceding vehicle to ease the accelerator when the following vehicle slips while being driven according to the first embodiment.

FIG. 7 is a block diagram illustrating a configuration of the preceding vehicle following system that performs control of causing the preceding vehicle to apply the brake while maintaining a trajectory when the following vehicle slips while being steered according to the first embodiment.

FIG. 8 is a block diagram illustrating a configuration of a preceding vehicle following system that controls the preceding vehicle to maintain ride comfort on the following vehicle according to a second embodiment.

FIG. 9 illustrates an exemplary modification of FIG. 8.

FIG. 10 is a block diagram illustrating a configuration of the preceding vehicle following system that controls the preceding vehicle according to a running mode of the following vehicle to maintain the ride comfort on the following vehicle according to the second embodiment.

FIG. 11 illustrates an exemplary modification of FIG. 10.

FIG. 12 is a block diagram illustrating a configuration of a preceding vehicle following system when there is a difference in minimum rotational radius between the preceding vehicle and the following vehicle according to a third embodiment.

FIG. 13 illustrates an exemplary modification of FIG. 12.

FIG. 14 is a block diagram illustrating a configuration of the preceding vehicle following system when there is a difference in engine performance between the preceding vehicle and the following vehicle according to the third embodiment.

FIG. 15 are timing charts of the preceding vehicle following system when there is a difference in engine performance between the preceding vehicle and the following vehicle according to the third embodiment.

FIG. 16 is a block diagram illustrating a configuration of the preceding vehicle following system when there is a difference in brake performance between the preceding vehicle and the following vehicle according to the third embodiment.

FIG. 17 are timing charts of the preceding vehicle following system when there is a difference in brake performance between the preceding vehicle and the following vehicle according to the third embodiment.

### DESCRIPTION OF EMBODIMENTS

In the following description, embodiments of the present invention will be described in detail with reference to the drawings.

### First Embodiment

A preceding vehicle following system based on which the present embodiment is constructed includes a preceding vehicle and a following vehicle running while non-mechanically following behind the preceding vehicle. The following vehicle is a vehicle equipped with a distance sensor that measures a distance to the preceding vehicle, an inter-vehicle communication apparatus that communicates with the preceding vehicle, and the like, and configured to run while following behind the preceding vehicle by being electronically connected to the preceding vehicle. The following vehicle automatically follows behind the preceding vehicle while maintaining a constant distance to the preceding vehicle along exactly the same trajectory as the preceding vehicle.

Now, when the following vehicle slips on a slippery road surface such as a snowy road, this may make it impossible for the following vehicle to run while always maintaining the constant distance to the preceding vehicle, because the distance between the following vehicle and the preceding vehicle reduces if this slip occurs during braking or increases if this slip occurs during driving.

Therefore, the present embodiment will be described below regarding a system that transmits a restriction value for preventing a tire force of the following vehicle from being saturated from the following vehicle to the preceding vehicle, and controls the preceding vehicle.

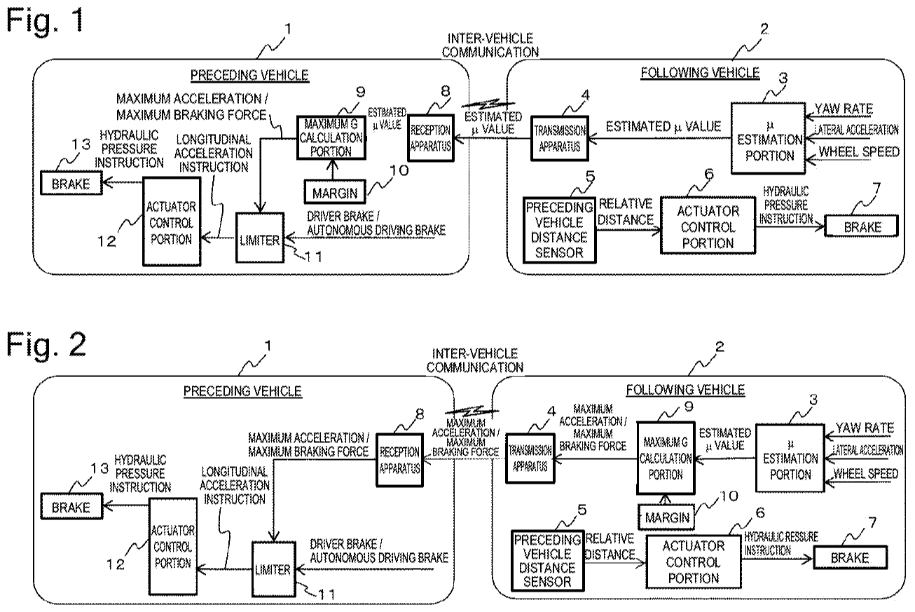

FIG. 1 is a block diagram illustrating a configuration of an preceding vehicle following system that performs control of causing the preceding vehicle to ease the brake when the following vehicle slips while being braked according to the present embodiment.

Referring to FIG. 1, a following vehicle 2 includes a p estimation portion 3, a transmission apparatus 4, a preceding vehicle distance sensor 5, an actuator control portion 6, and a brake 7. The p estimation portion 3 is a road surface state acquisition portion that estimates a frictional coefficient μ of a road surface where a wheel contacts the ground based on information indicating a yaw rate (an angular speed), a lateral acceleration of the vehicle, and a wheel speed. The transmission apparatus 4 transmits the estimated p value to a preceding vehicle 1. The preceding vehicle distance sensor 5 measures the relative distance to the preceding vehicle 1. The actuator control portion 6 calculates and outputs an instruction value for a brake hydraulic pressure, which is an amount of controlling the brake (a braking apparatus) 7, based on the measured relative distance. The brake 7 is an actuator regarding braking that is controlled by the actuator control portion 6.

Further, the preceding vehicle 1 includes a reception apparatus 8, a maximum G calculation portion 9, a margin setting portion 10, a limiter 11, an actuator control portion 12, and a brake 13. The reception apparatus 8 receives the estimated p value transmitted from the following vehicle 2. The maximum G calculation portion 9 calculates a maximum acceleration (G) or a maximum braking force based on the estimated p value. The margin setting portion 10 functions to provide a margin when calculating the maximum acceleration or the maximum braking force by the maximum G calculation portion 9. The limiter 11 imposes a limitation on the maximum acceleration or the maximum braking force from the maximum G calculation portion 9 according to a brake operation performed by a driver or autonomous driving. The actuator control portion 12 calculates and outputs an instruction value for a brake hydraulic pressure, which is an amount of controlling the brake 13, according to an instruction for a longitudinal acceleration of the vehicle from the limiter 11. The brake 13 is controlled by the actuator control portion 12.

FIG. 2 illustrates an exemplary modification of FIG. 1. The preceding vehicle 1 performs the processing for calculating the acceleration by providing the margin to the maximum G calculation portion 9 based on the estimated p value in FIG. 1. However, to cause this processing to be performed by the following vehicle 2, the following vehicle 2 is provided with the maximum G calculation portion 9 and the margin setting portion 10 and transmits the maximum acceleration or the maximum braking force calculated by the maximum G calculation portion 9 to the preceding vehicle 1 via the transmission apparatus 4 as illustrated in FIG. 2.

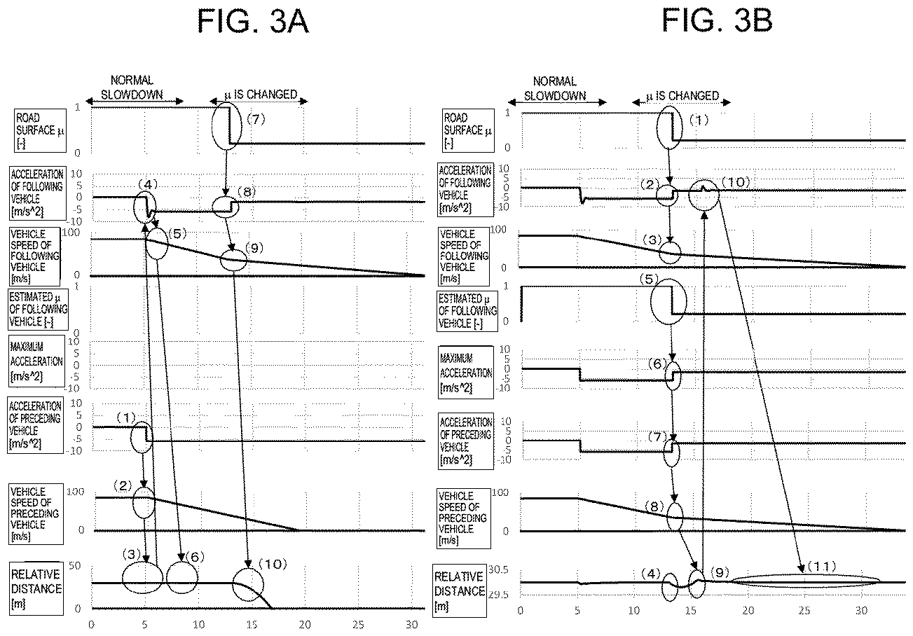

FIG. 3 are timing charts of the preceding vehicle following system that performs control of causing the preceding vehicle to ease the brake when the following vehicle slips while being braked according to the present embodiment. More specifically, FIG. 3(A) illustrates the timing chart when the control according to the present embodiment is not performed, while FIG. 3(B) illustrates the timing chart when the control according to the present embodiment is performed.

First, this preceding vehicle following system will be described focusing on the timing chart when the control according to the present embodiment is not performed illustrated in FIG. 3(A). In FIG. 3(A), when the preceding vehicle applies the brake with the preceding vehicle following in operation as the premise thereof, the acceleration and the vehicle speed of the preceding vehicle reduce as indicated by (1) and (2), and the relative distance between the preceding vehicle and the following vehicle indicated by (3) is about to reduce, so that the following vehicle applies the brake according to the follow control. Then, the following vehicle also slows down with the same acceleration as the acceleration of the preceding vehicle with use of the PID control as indicated by (4) and (5). As a result, the following vehicle slows down with the same speed as the preceding vehicle, thereby keeping the relative distance constant as indicated by (6). Then, when the following vehicle slips while being braked due to a reduction in the road surface p as indicated by (7), the following vehicle fails to sufficiently apply the brake, thereby failing to sufficiently reduce the acceleration and the vehicle speed thereof as indicated by (8) and (9), thus resulting in running at a different vehicle speed from the preceding vehicle since the preceding vehicle is slowing down normally. Therefore, as indicated by (10), the following vehicle reduces the relative distance to the preceding vehicle, and might lose the relative distance and undesirably collide with the preceding vehicle in the worst case.

Next, the present preceding vehicle following system will be described focusing on the timing chart when the control according to the present embodiment is performed illustrated in FIG. 3(B). In FIG. 3(B), when the following vehicle slips while being braked due to a reduction in the road surface p as indicated by (1), the following vehicle fails to sufficiently apply the brake, thereby failing to sufficiently reduce the acceleration and the vehicle speed thereof as indicated by (2) and (3), thus resulting in running at a different vehicle speed from the preceding vehicle. Therefore, as indicated by (4), the following vehicle runs at a different vehicle speed from the preceding vehicle since the preceding vehicle is slowing down normally, thereby reducing the relative distance to the preceding vehicle. At this time, the following vehicle measures the estimated p as indicated by (5). Then, the preceding vehicle 1 calculates the maximum acceleration based on the estimated p as indicated by (6), provides the margin thereto, and slows down with a lower acceleration than the following vehicle as indicated by (7) and (8). In other words, the preceding vehicle eases the brake, thereby increasing the relative distance as indicated by (9). Then, the following vehicle also slows down with the same acceleration as the acceleration of the preceding vehicle with use of the PID control as indicated by (10). As a result, the following vehicle slows down with the same acceleration as the preceding vehicle, thereby keeping the relative distance constant as indicated by (11).

In this manner, the restriction is imposed on the preceding vehicle automatically based on the constraint on the braking of the following vehicle, and therefore the following vehicle can run while further appropriately following behind the preceding vehicle.

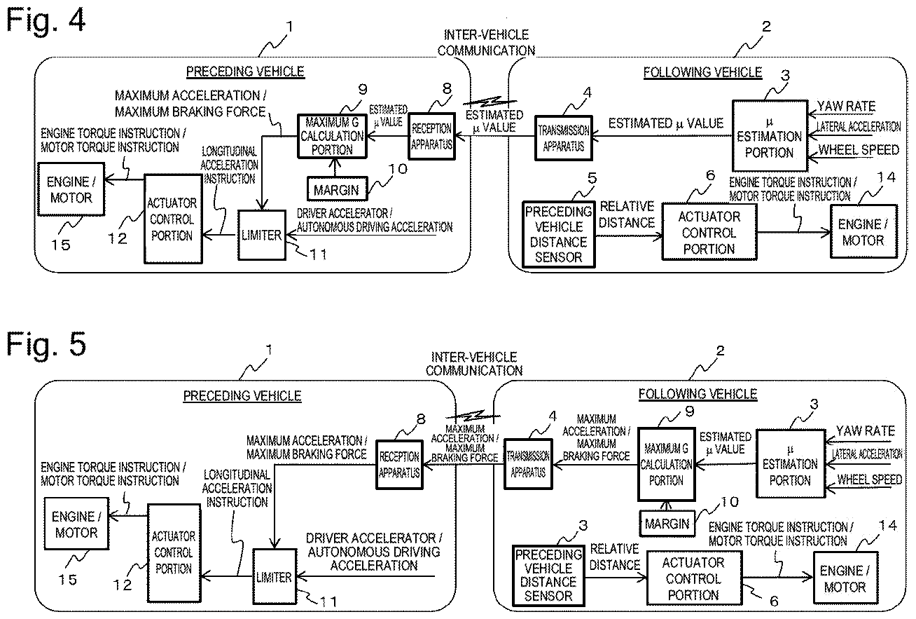

FIG. 4 is a block diagram illustrating a configuration of the preceding vehicle following system that performs control of causing the preceding vehicle to ease the accelerator when the following vehicle slips while being driven (an accelerator operation) according to the present embodiment.

In FIG. 4, functions similar to FIG. 1 will be identified by the same reference numerals, and descriptions thereof will be omitted. A difference of FIG. 4 from FIG. 1 is that the following vehicle 2 includes an engine/motor 14, which is an actuator regarding the driving that is controlled by the actuator control portion 6, and the actuator control portion 6 calculates and outputs an engine torque instruction or a motor torque instruction, which is an amount of controlling the engine/motor 14, based on the relative distance. Another difference is that the preceding vehicle 1 includes an engine/motor 15 controlled by the actuator control portion 12, and the actuator control portion 12 calculates and outputs an engine torque instruction or a motor torque instruction, which is an amount of controlling the engine/motor 15, based on the longitudinal acceleration of the vehicle from the limiter 11. Further, the limiter 11 is a limiter 11 that limits the maximum acceleration or the maximum braking force from the maximum G calculation portion 9 according to an accelerator operation performed by the driver or acceleration by the autonomous driving.

FIG. 5 illustrates an exemplary modification of FIG. 4. The preceding vehicle 1 performs the processing for calculating the acceleration by providing the margin to the maximum G calculation portion 9 based on the estimated p value in FIG. 4. However, to cause this processing to be performed by the following vehicle 2, the following vehicle 2 is provided with the maximum G calculation portion 9 and the margin setting portion 10 and transmits the maximum acceleration or the maximum braking force calculated by the maximum G calculation portion 9 to the preceding vehicle 1 via the transmission apparatus 4 as illustrated in FIG. 5.

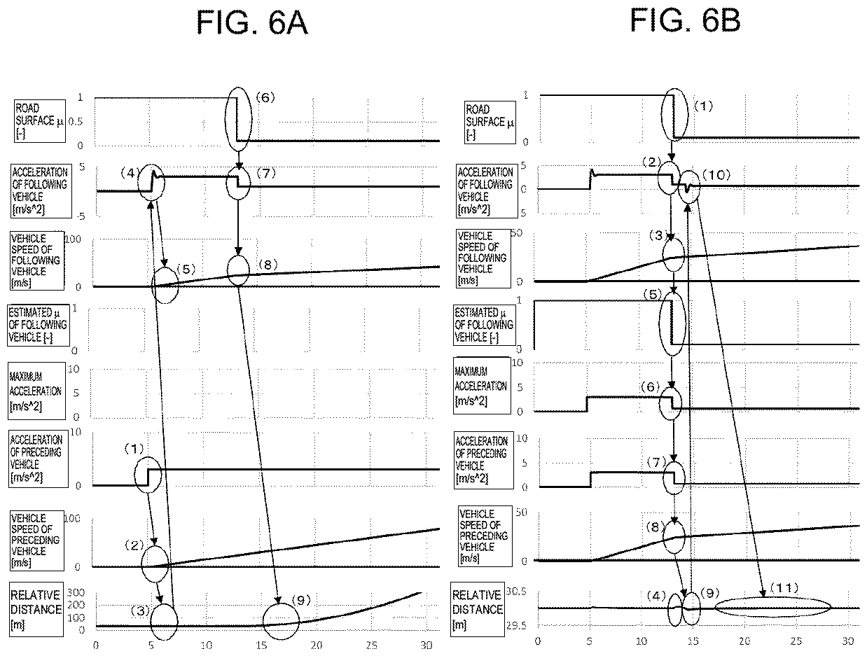

FIG. 6 are timing charts of the preceding vehicle following system that performs the control of causing the preceding vehicle to ease the accelerator when the following vehicle slips while being driven according to the first embodiment. More specifically, FIG. 6(A) illustrates the timing chart when the control according to the present embodiment is not performed, while FIG. 6(B) illustrates the timing chart when the control according to the present embodiment is performed.

First, this preceding vehicle following system will be described focusing on the timing chart when the control according to the present embodiment is not performed illustrated in FIG. 6(A). In FIG. 6(A), when the accelerator is pressed on the preceding vehicle with both the vehicles stopped as the premise thereof, the acceleration and the vehicle speed of the preceding vehicle increase as indicated by (1) and (2), and the relative distance between the preceding vehicle and the following vehicle indicated by (3) is about to increase, so that the following vehicle is driven by the conventional follow control and also speeds up with the same acceleration as the acceleration of the preceding vehicle with use of the PID control as indicated by (4) and (5). As a result, the following vehicle speeds up with the same speed as the preceding vehicle, thereby keeping the relative distance constant. Then, when the following vehicle slips while being driven due to a reduction in the road surface p as indicated by (6), the following vehicle fails to sufficiently apply the driving force, thereby failing to sufficiently increase the acceleration and the vehicle speed thereof as indicated by (7) and (8), thus resulting in running at a different vehicle speed from the preceding vehicle since the preceding vehicle is speeding up normally. Therefore, as indicated by (9), the relative distance to the preceding vehicle undesirably increases.

Next, the preceding vehicle following system will be described focusing on the timing chart when the control according to the present embodiment is performed illustrated in FIG. 6(B). In FIG. 6(B), when the following vehicle slips while being driven due to a reduction in the road surface p as indicated by (1), the following vehicle fails to sufficiently apply the driving force, thereby failing to sufficiently increase the acceleration and the vehicle speed thereof as indicated by (2) and (3), thus resulting in running at a different vehicle speed from the preceding vehicle. Therefore, the following vehicle runs at a different vehicle speed from the preceding vehicle since the preceding vehicle is speeding up normally, thereby increasing the relative distance to the preceding vehicle as indicated by (4). At this time, the following vehicle measures the estimated p as indicated by (5). Then, the preceding vehicle 1 calculates the maximum acceleration based on the estimated p as indicated by (6), provides the margin thereto, and eases the accelerator so as to run at a lower acceleration than the following vehicle as indicated by (7) and (8). In other words, the preceding vehicle eases the accelerator, thereby reducing the relative distance as indicated by (9). Then, the following vehicle also speeds up with the same acceleration as the acceleration of the preceding vehicle with use of the PID control as indicated by (10). As a result, the following vehicle speeds up with the same acceleration as the preceding vehicle, thereby keeping the relative distance constant as indicated by (11).

In this manner, the restriction is imposed on the preceding vehicle automatically based on the constraint on the driving of the following vehicle, and therefore the following vehicle can run while further appropriately following behind the preceding vehicle.

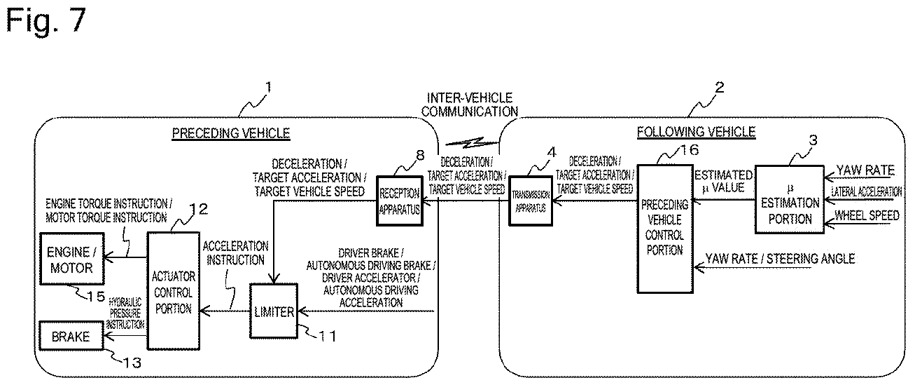

FIG. 7 is a block diagram illustrating a configuration of the preceding vehicle following system that performs control of causing the preceding vehicle to apply the brake while maintaining the trajectory when the following vehicle slips while being steered (a steering operation) according to the present embodiment.

When the following vehicle slips while being steered in the vehicle follow control on the way of a curve, if the preceding vehicle runs at the same speed as before, the following vehicle would attempt to run at the same speed and therefore might undesirably slide off the course. Therefore, when the following vehicle slips while being steered, the preceding vehicle performs control of applying the brake while maintaining the trajectory.

In FIG. 7, functions similar to FIGS. 1 and 4 will be identified by the same reference numerals, and descriptions thereof will be omitted. A difference of FIG. 7 from FIGS. 1 and 4 is that the following vehicle 2 includes a preceding vehicle restriction portion 16, and calculates a deceleration/target acceleration/target vehicle speed of the preceding vehicle based on the estimated p value from the p estimation portion 3 and the yaw rate or the steering angle and then transmits it to the preceding vehicle 1 via the transmission apparatus 4. Another difference is that the preceding vehicle 1 includes the engine/motor 15 and the brake 13 controlled by the actuator control portion 12, and the actuator control portion 12 calculates and outputs the engine torque instruction or the motor torque instruction, which is the amount of controlling the engine/motor 15, and the instruction value for the brake hydraulic pressure, which is the amount of controlling the brake 13, based on the acceleration instruction from the limiter 11. Further, the limiter 11 is a limiter 11 that limits the deceleration/target acceleration/target vehicle speed according to the accelerator operation performed by the driver or the acceleration/deceleration by the autonomous driving.

Due to this configuration, when the following vehicle is about to slip during the steering operation, the preceding vehicle eases the vehicle speed by limiting the engine, i.e., restricting the driving force or applying the brake. As a result, the following vehicle can run while following behind the preceding vehicle without slipping.

In this manner, the restriction is imposed on the preceding vehicle automatically based on the constraint on the steering of the following vehicle, and therefore the following vehicle can run while further appropriately following behind the preceding vehicle.

In this manner, according to the present embodiment, the preceding vehicle outputs the instruction for restricting the motion state of the braking, the driving, or the steering to impose the restriction on the motion state of the preceding vehicle according to the information regarding the vehicle performance that is the braking/driving/steering performance of the following vehicle in the running state, thereby allowing the following vehicle to further appropriately follow behind the preceding vehicle even when being subjected to the constraint.

The present embodiment has been described assuming that the preceding vehicle restricts the motion state of the braking, the driving, or the steering by transmitting the acceleration instruction to the actuator control portion in the above description, but the preceding vehicle may output an output instruction that is a notification using a warning sound or a warning lamp to cause the driver of the preceding vehicle to restrict the motion state of the preceding vehicle based on this output instruction. In this case, the driver sets the restriction on the preceding vehicle based on the constraint on the following vehicle, thereby being able to recognize that the restriction is imposed.

### Second Embodiment

The present embodiment will be described regarding a preceding vehicle following system that controls the preceding vehicle to maintain ride comfort on the following vehicle and abide by a running rule of the following vehicle.

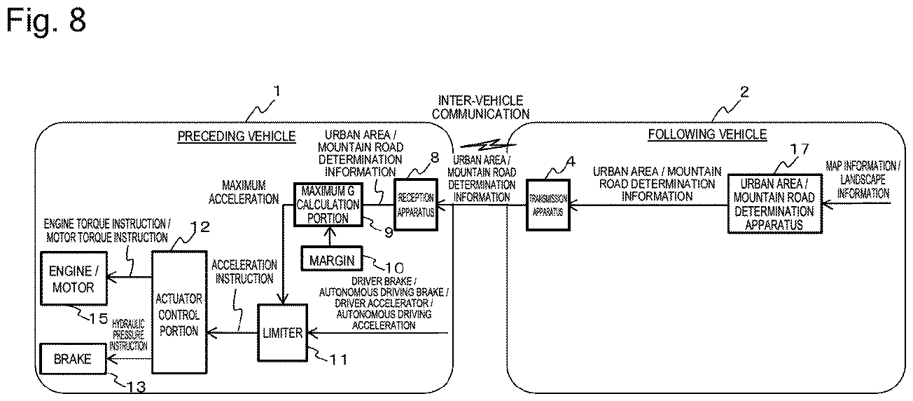

FIG. 8 is a block diagram illustrating a configuration of the preceding vehicle following system that controls the preceding vehicle to maintain the ride comfort on the following vehicle according to the present embodiment.

In FIG. 8, for example, even when a great value is set as the G to be generated, this less affects the driver when the vehicle runs on a mountain road compared to when the vehicle runs on a flat area or an urban area. Therefore, the preceding vehicle is controlled so as to be able to generate a high G when running on a mountain road compared to when running on a flat area or an urban area. The present embodiment allows the following vehicle to swiftly and comfortably run as a result thereof.

In FIG. 8, functions similar to FIGS. 1, 4, and 7 will be identified by the same reference numerals, and descriptions thereof will be omitted. A difference of FIG. 8 from FIGS. 1, 4, and 7 is that the following vehicle 2 includes an urban area/mountain road determination apparatus 17. The urban area/mountain road determination apparatus 17 determines whether the running location is an urban area or a mountain road based on information regarding the geography included in information regarding the map such as position/map information indicated by a car navigation system or the like and landscape information acquired by a camera. Then, the urban area/mountain road determination apparatus 17 transmits this urban area/mountain road determination information to the preceding vehicle 1 via the transmission apparatus 4. The preceding vehicle 1 calculates the maximum G suitable to the running location by the maximum G calculation portion 9 based on the received urban area/mountain road determination information, and controls the engine/motor 15 and the brake 13 to control the preceding vehicle so as to allow the following vehicle to run at the maximum G suitable to the running location.

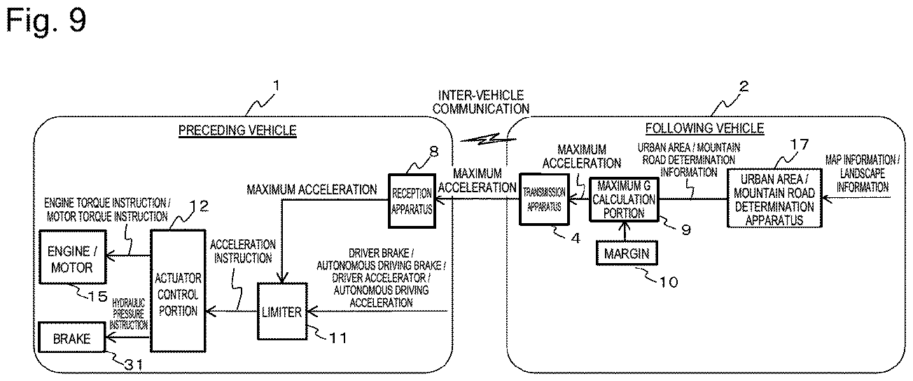

Further, FIG. 9 illustrates an exemplary modification of FIG. 8. In FIG. 8, the urban area/mountain road determination information calculated by the urban area/mountain road determination apparatus 17 is transmitted to the preceding vehicle and the preceding vehicle 1 performs the processing for calculating the maximum G suitable to the running location by the maximum G calculation portion 9 based on the urban area/mountain road determination information. However, to cause this processing to be performed by the following vehicle 2, the following vehicle 2 is provided with the maximum G calculation portion 9 and the margin setting portion 10 and transmits the maximum acceleration calculated by the maximum G calculation portion 9 to the preceding vehicle 1 via the transmission apparatus 4 as illustrated in FIG. 9.

In this manner, in the present embodiment, the preceding vehicle following system allows the following vehicle to follow behind the preceding vehicle while maintaining the ride comfort thereon. Further, even when a reference value such as the lateral G of the following vehicle increases because the following vehicle follows behind the preceding vehicle, the preceding vehicle following system allows the following vehicle to follow behind the preceding vehicle within the reference value by imposing the restriction on the preceding vehicle.

Further, in FIGS. 8 and 9, the preceding vehicle following system is provided with a running rule extraction apparatus that extracts information regarding the running rule, such as the speed limit at the running location and a prescribed value of a lane keep assist system, based on the above-described information regarding the map such as the position/map information indicated by the car navigation system and the landscape information acquired by the camera instead of the urban area/mountain road determination apparatus 17, thereby being able to control the preceding vehicle based on the information regarding the running rule from the following vehicle and thus allow the following vehicle to run while abiding by the running prescribed value or the like.

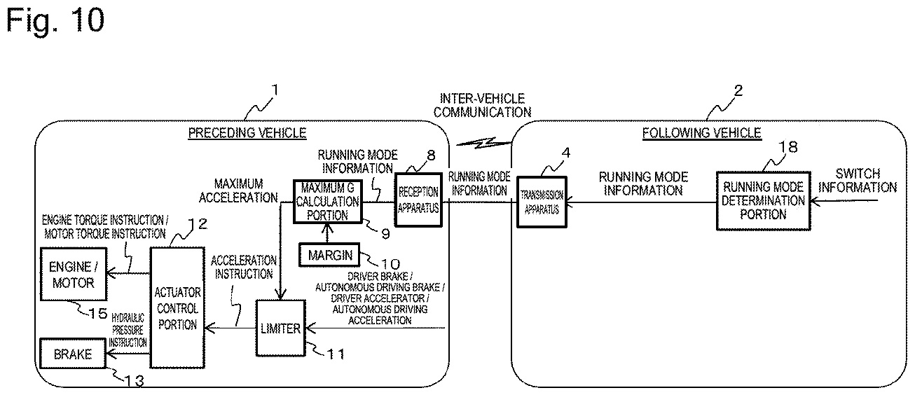

FIG. 10 is a block diagram illustrating a configuration of the preceding vehicle following system that controls the preceding vehicle according to a running mode of the following vehicle to maintain the ride comfort on the following vehicle according to the present embodiment.

In FIG. 10, the following vehicle 2 is configured to allow a person riding in the following vehicle to select the running mode of the following vehicle according to each of a state that the person wants to enjoy the scenery or a situation that the person wants to reach the destination quickly. The preceding vehicle following system calculates the maximum acceleration according to the selected running mode, and the preceding vehicle imposes the restriction on the running thereof based on this information.

In FIG. 10, functions similar to FIG. 8 will be identified by the same reference numerals, and descriptions thereof will be omitted. A difference of FIG. 10 from FIG. 8 is that the following vehicle 2 includes a running mode determination portion 18. The running mode determination portion 18 determines any of a plurality of running modes based on switch information specified by the user and selects and outputs running mode information corresponding to the running mode determined from a plurality of pieces of running mode information. Then, the following vehicle 2 transmits this running mode information to the preceding vehicle 1 via the transmission apparatus 4. The preceding vehicle 1 calculates the maximum G suitable to the running mode by the maximum G calculation portion 9 based on the received running mode information, and controls the engine/motor 15 and the brake 13 to control the preceding vehicle so as to allow the following vehicle to run in the selected running mode.

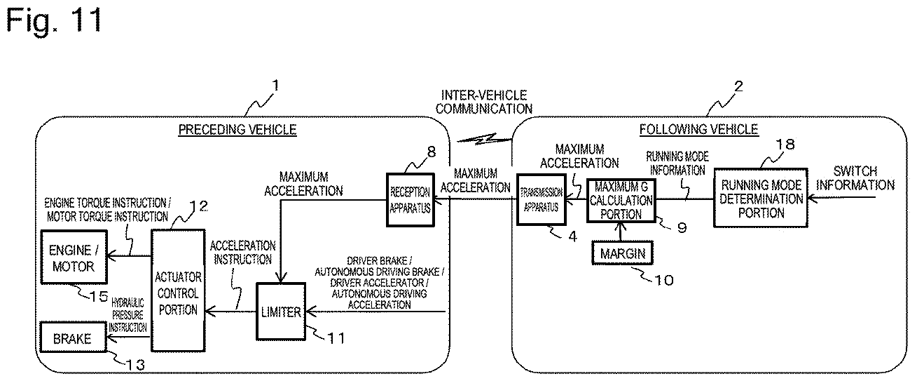

Further, FIG. 11 illustrates an exemplary modification of FIG. 10. The running mode information calculated by the running mode determination portion 18 is transmitted to the preceding vehicle, and the preceding vehicle 1 performs the processing for calculating the maximum G suitable to the running mode by the maximum G calculation portion 9 based on the running mode information in FIG. 10. However, to cause this processing to be performed by the following vehicle 2, the following vehicle 2 is provided with the maximum G calculation portion 9 and the margin setting portion 10 and transmits the maximum acceleration calculated by the maximum G calculation portion 9 to the preceding vehicle 1 via the transmission apparatus 4 as illustrated in FIG. 11.

In this manner, the following vehicle has the plurality of running modes, and the preceding vehicle following system allows the following vehicle to run in the desired running mode with the aid of the vehicle follow control by controlling the preceding vehicle according to the selected running mode.

In this manner, according to the present embodiment, the preceding vehicle following system allows the following vehicle to further appropriately follow behind the preceding vehicle by controlling the preceding vehicle to maintain the ride comfort on the following vehicle and abide by the running rule of the following vehicle.

### Third Embodiment

The present embodiment will be described regarding an preceding vehicle following system that controls the vehicle performance of the preceding vehicle in such a manner that it matches the vehicle specifications of the following vehicle. The vehicle specifications refer to, for example, a minimum rotational radius (R) under the vehicle standard, the engine performance, and the brake performance.

For example, in a case where the following vehicle is a vehicle larger than the preceding vehicle and has a larger minimum rotational radius than the preceding vehicle, if the preceding vehicle runs with a smaller minimum rotational radius than the following vehicle, the following vehicle cannot run along the trajectory along which the preceding vehicle runs, ending up undesirably running outside the trajectory of the preceding vehicle. Therefore, in the present embodiment, the preceding vehicle following system restricts the steering angle of the preceding vehicle, thereby ensuring that the following vehicle can follow behind the preceding vehicle.

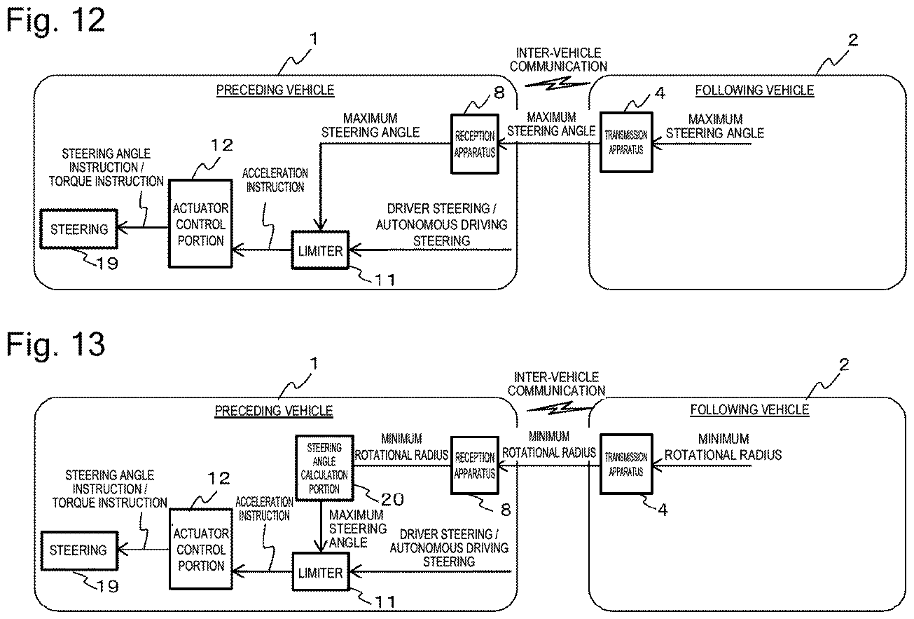

FIG. 12 is a block diagram illustrating a configuration of the preceding vehicle following system when there is a difference in minimum rotational radius between the preceding vehicle and the following vehicle according to the present embodiment. In FIG. 12, functions similar to FIG. 8 will be identified by the same reference numerals, and descriptions thereof will be omitted. A difference of FIG. 12 from FIG. 8 is that the following vehicle 2 transmits a maximum steering angle, which is information regarding the minimum rotational radius, to the preceding vehicle 1 via the transmission apparatus 4. The preceding vehicle 1 includes a steering 19 that is an actuator regarding the steering controlled by the actuator control portion 12 according to a steering angle instruction or a torque instruction based on the received maximum steering angle.

Further, FIG. 13 illustrates an exemplary modification of FIG. 12. The maximum steering angle is transmitted to the preceding vehicle in FIG. 12. However, in FIG. 13, the minimum rotational radius is transmitted to the preceding vehicle, and the preceding vehicle side includes a steering angle calculation portion 20 that calculates the maximum steering angle based on the minimum rotational radius, and controls the steering 19 by the actuator control portion 12 based on this calculated maximum steering angle.

In this manner, the preceding vehicle following system allows the following vehicle to follow the trajectory along which the preceding vehicle runs even when the following vehicle is a large-size vehicle and the preceding vehicle is a small-size vehicle capable of turning in a small radius, by restricting the steering angle of the preceding vehicle in such a manner that it matches the minimum rotational radius of the following vehicle.

The present embodiment will be further described regarding an example when there is a difference between the preceding vehicle and the following vehicle in terms of the engine performance among the vehicle specifications.

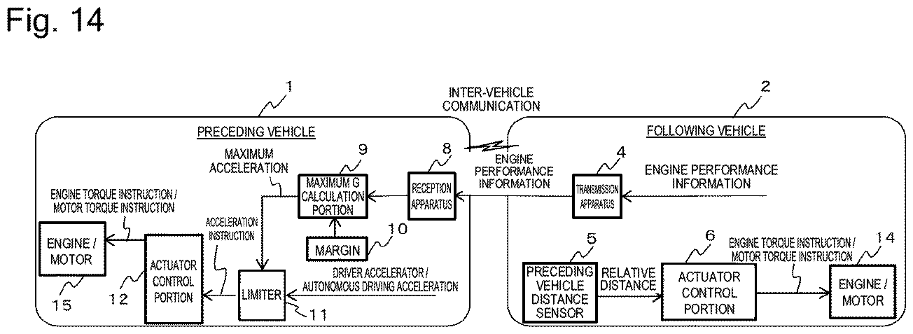

FIG. 14 is a block diagram illustrating a configuration of the preceding vehicle following system when there is a difference in engine performance between the preceding vehicle and the following vehicle according to the present embodiment.

In FIG. 14, functions similar to FIG. 4 will be identified by the same reference numerals, and descriptions thereof will be omitted. A difference of FIG. 14 from FIG. 4 is that the following vehicle 2 transmits engine performance information to the preceding vehicle 1 via the transmission apparatus 4. The preceding vehicle 1 calculates the maximum acceleration of the following vehicle based on the received engine performance information, and controls the engine/motor 15 according to the engine torque instruction or the motor torque instruction by the actuator control portion 12.

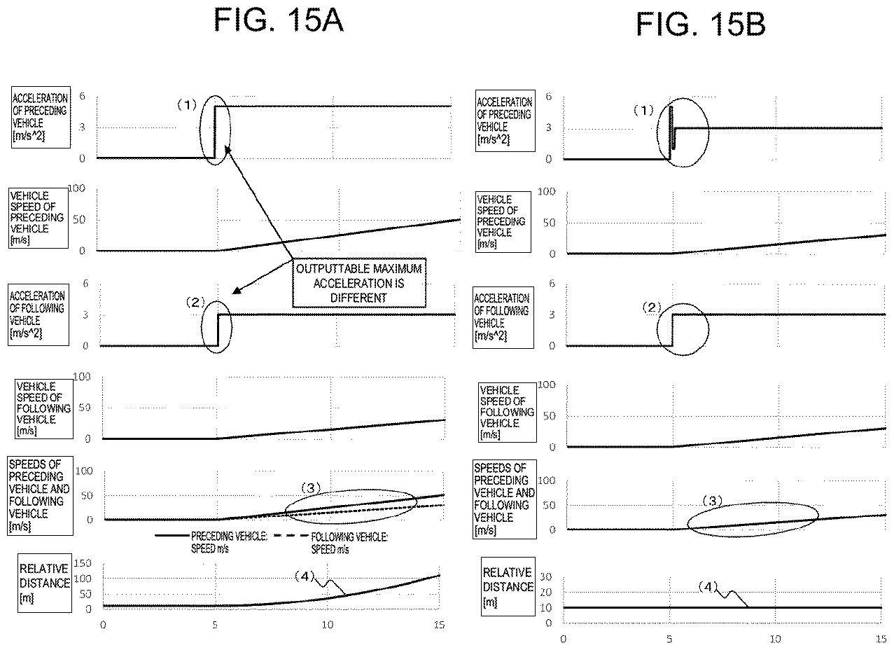

FIG. 15 are timing charts of the preceding vehicle following system when there is a difference in engine performance between the preceding vehicle and the following vehicle according to the present embodiment. More specifically, FIG. 15(A) illustrates the timing chart when the control according to the present embodiment is not performed, while FIG. 15(B) illustrates the timing chart when the control according to the present embodiment is performed.

First, this preceding vehicle following system will be described focusing on the timing chart when the control according to the present embodiment is not performed illustrated in FIG. 15(A). In FIG. 15(A), when the outputtable maximum acceleration is different between the preceding vehicle and the following vehicle as indicated by (1) and (2), the vehicle speed derived from the driving is different between the preceding vehicle and the following vehicle as indicated by (3). Therefore, the relative distance between the preceding vehicle and the following vehicle due to the follow control gradually increases as indicated by (4).

Next, the present preceding vehicle following system will be described focusing on the timing chart when the control according to the present embodiment is performed illustrated in FIG. 15(B). In FIG. 15(B), the acceleration of the preceding vehicle is restricted based on the maximum acceleration of the following vehicle as indicated by (1). Due to this restriction, the acceleration of the preceding vehicle becomes equal to the acceleration of the following vehicle as indicated by (2). As a result, the preceding vehicle and the following vehicle have equal vehicle speeds derived from the driving as indicated by (3), thereby keeping constant the relative distance generated between the preceding vehicle and the following vehicle due to the follow control as indicated by (4).

The preset embodiment can provide the preceding vehicle following system that allows the following vehicle to follow behind the preceding vehicle even when the following vehicle has a lower acceleration performance than the preceding vehicle, such as being late in raising the acceleration and being low in maximum acceleration, by restricting the acceleration when the preceding vehicle speeds up.

Next, the present embodiment will be further described regarding an example when there is a difference between the preceding vehicle and the following vehicle in terms of the brake performance among the vehicle specifications.

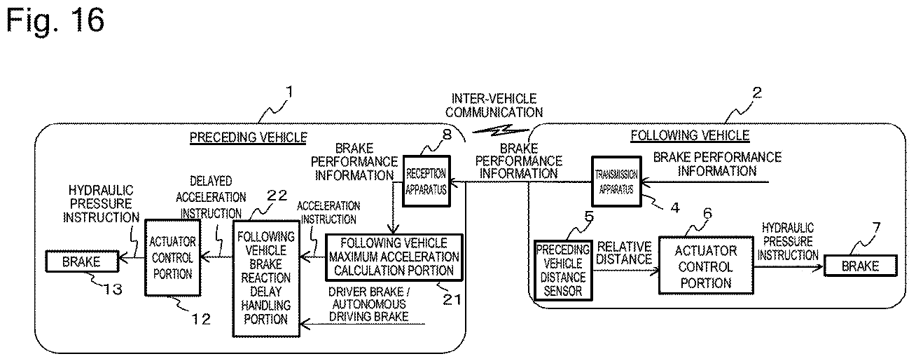

FIG. 16 is a block diagram illustrating a configuration of the preceding vehicle following system when there is a difference in brake performance between the preceding vehicle and the following vehicle according to the present embodiment. In FIG. 16, functions similar to FIG. 1 will be identified by the same reference numerals, and descriptions thereof will be omitted. A difference of FIG. 16 from FIG. 1 is that the following vehicle 2 transmits brake performance information to the preceding vehicle 1 via the transmission apparatus 4. The preceding vehicle 1 includes a following vehicle maximum acceleration portion 21, which calculates the maximum acceleration of the following vehicle based on the received brake performance information, and a following vehicle brake reaction delay handling portion 22, which outputs a delayed acceleration instruction, and controls the brake 13 by outputting a hydraulic instruction by the actuator control portion 12 according to the delayed acceleration instruction.

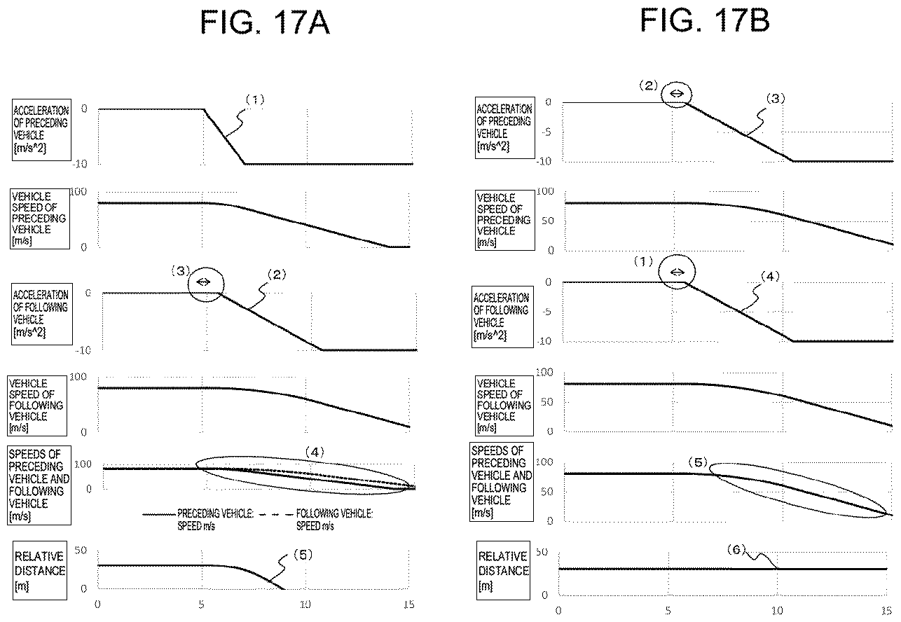

FIG. 17 are timing charts of the preceding vehicle following system when there is a difference in brake performance between the preceding vehicle and the following vehicle according to the present embodiment. More specifically, FIG. 17(A) illustrates the timing chart when the control according to the present embodiment is not performed, while FIG. 17(B) illustrates the timing chart when the control according to the present embodiment is performed.

First, this preceding vehicle following system will be described focusing on the timing chart when the control according to the present embodiment is not performed illustrated in FIG. 17(A). In FIG. 17(A), when the preceding vehicle applies the brake with the vehicle follow control in operation as the premise thereof, their respective accelerations have different gradients as far as the maximum decelerations due to the difference in brake performance between the preceding vehicle and the following vehicle as indicated by (1) and (2). Further, the brake of the following vehicle exhibits a response delay as indicated by (3). Therefore, the preceding vehicle and the following vehicle have different vehicle speeds derived from the braking even including deceleration start points as indicated by (4). As a result, the relative distance between the preceding vehicle and the following vehicle due to the follow control gradually reduces as indicated by (5).

Next, the present preceding vehicle following system will be described focusing on the timing chart when the control according to the present embodiment is performed illustrated in FIG. 17(B). In FIG. 17(B), the preceding vehicle applies the brake after waiting for the deceleration/acceleration instruction as indicated by (2) in synchronization with the timing of the response delay of the brake of the following vehicle, which is indicated by (1), by the above-described following vehicle brake response delay handling portion 22. Further, the deceleration/acceleration of the preceding vehicle is restricted based on the maximum acceleration for the deceleration that is adjusted in conformity with the brake performance of the following vehicle by the above-described following vehicle maximum acceleration portion 21. Due to this restriction, the preceding vehicle and the following vehicle exhibit the same deceleration point and gradient of the deceleration/acceleration as indicated by (3) and (4). As a result, the preceding vehicle and the following vehicle have equal vehicle speeds derived from the braking as indicated by (5), thereby keeping constant the relative distance generated between the preceding vehicle and the following vehicle due to the follow control as indicated by (6).

In this manner, the present embodiment can provide the preceding vehicle following system that allows the following vehicle to follow behind the preceding vehicle even when the following vehicle requires a longer distance for the braking than the preceding vehicle by easing the rise of the deceleration/acceleration of the preceding vehicle to allow the following vehicle to also stop concurrently therewith.

In this manner, according to the present embodiment, the preceding vehicle following system allows the following vehicle to further appropriately follow behind the preceding vehicle by imposing the restriction on the preceding vehicle according to the vehicle specifications of the following vehicle.

Having described the embodiments, the present invention is not limited to the above-described embodiments and includes various modifications. For example, the above-described embodiments have been described in detail to facilitate a better understanding of the present invention, and the present invention is not necessarily limited to the configuration including all of the described features. Further, a part of the configuration of some embodiment can be replaced with the configuration of another embodiment, and some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2018-46239 filed on Mar. 14, 2018. The entire disclosure of Japanese Patent Application No. 2018-46239 filed on Mar. 14, 2018 including the specification, the claims, the drawings, and the abstract is incorporated herein by reference in its entirety.

### REFERENCE SIGNS LIST

1: preceding vehicle
2: following vehicle
3: p estimation portion
4: transmission apparatus
5: preceding vehicle distance sensor
6, 12: actuator control portion
7, 13: brake
8: reception apparatus
9: maximum G calculation portion
10: margin setting portion
11: limiter
14, 15: engine/motor
16: preceding vehicle control portion
17: urban area/mountain road determination apparatus
18: running mode determination portion
19: steering
20: steering angle calculation portion
21: following vehicle maximum acceleration calculation portion
22: following vehicle brake response delay handling portion

1. A vehicle control apparatus configured to be mounted on a preceding vehicle in a preceding vehicle following system that performs follow control by non-mechanically connecting the preceding vehicle and a following vehicle,
wherein the vehicle control apparatus outputs an instruction for restricting a motion state of the preceding vehicle to the preceding vehicle based on information regarding an input vehicle performance of the following vehicle.

2. The vehicle control apparatus according to claim 1, wherein the output instruction for restricting the motion state of the preceding vehicle is input to an actuator regarding braking, driving, or steering of the preceding vehicle.

3. The vehicle control apparatus according to claim 2, wherein the vehicle performance is a maximum acceleration of the following vehicle that is determined based on a frictional coefficient of a road surface where a wheel of the following vehicle contacts the ground, the frictional coefficient being acquired by a road surface state acquisition portion mounted on the following vehicle.

4. The vehicle control apparatus according to claim 3, wherein the actuator includes a braking actuator regarding the braking, and
wherein, when the preceding vehicle and the following vehicle are in a braking state, an instruction for reducing a braking force is output to the braking actuator based on the maximum acceleration of the following vehicle, the maximum acceleration being determined based on the frictional coefficient on the road surface where the wheel of the following vehicle contacts the ground.

5. The vehicle control apparatus according to claim 3, wherein the actuator includes a driving actuator regarding the driving, and
wherein, when the preceding vehicle and the following vehicle are in a driving state, an instruction for reducing a driving force is output to the driving actuator based on the maximum acceleration of the following vehicle, the maximum acceleration being determined based on the frictional coefficient on the road surface where the wheel of the following vehicle contacts the ground.

6. The vehicle control apparatus according to claim 3, wherein the actuator includes a braking actuator regarding the braking and a driving actuator regarding the driving, and
wherein, when the preceding vehicle and the following vehicle are in a curve running state, an instruction for reducing a driving force is output to the driving actuator or an instruction for enhancing a braking force is output to the braking actuator based on the maximum acceleration of the following vehicle, the maximum acceleration being determined based on the frictional coefficient on the road surface where the wheel of the following vehicle contacts the ground.

7. The vehicle control apparatus according to claim 2, wherein the vehicle performance is a maximum acceleration of the following vehicle, the maximum acceleration being determined based on information regarding a map that is acquired by the following vehicle.

8. The vehicle control apparatus according to claim 7, wherein the actuator includes a braking actuator regarding the braking and a driving actuator regarding the driving, and
wherein an instruction for restricting a driving force is output to the driving actuator or an instruction for restricting a braking force is output to the braking actuator based on information regarding a geography included in the information regarding the map that is acquired by the following vehicle.

9. The vehicle control apparatus according to claim 7, wherein the actuator includes a braking actuator regarding the braking and a driving actuator regarding the driving, and
wherein an instruction for restricting a driving force is output to the driving actuator or an instruction for restricting a braking force is output to the braking actuator based on information regarding a running prescribed value included in the information regarding the map that is acquired by the following vehicle.

10. The vehicle control apparatus according to claim 2, wherein the vehicle performance is vehicle specifications of the following vehicle.

11. The vehicle control apparatus according to claim 10, wherein the actuator includes a steering actuator regarding the steering, and
wherein an instruction for restricting a steering angle is output to the steering actuator based on information regarding a minimum rotational radius among the vehicle specifications of the following vehicle.

12. The vehicle control apparatus according to claim 10, wherein the actuator includes a driving actuator regarding the driving, and
wherein, when the preceding vehicle and the following vehicle are in a driving state, an instruction for restricting a driving force is output to the driving actuator based on information regarding a driving performance among the vehicle specifications of the following vehicle.

13. The vehicle control apparatus according to claim 10, wherein the actuator includes a braking actuator regarding the braking, and
wherein, when the preceding vehicle and the following vehicle are in a braking state, an instruction for restricting a braking force is output to the braking actuator based on information regarding a braking performance among the vehicle specifications of the following vehicle.

14. The vehicle control apparatus according to claim 1, wherein the output instruction for restricting the motion state of the preceding vehicle is a warning sound or a warning lamp that notifies a driver of the preceding vehicle.

15. The vehicle control apparatus according to claim 2, wherein the actuator includes a braking actuator regarding the braking and a driving actuator regarding the driving, and
wherein the following vehicle has a plurality of running modes, and the vehicle control apparatus outputs the instruction for restricting the motion state of the preceding vehicle to the preceding vehicle based on the information regarding the vehicle performance of the following vehicle corresponding to a selected running mode among the plurality of running modes.

16. A vehicle control method configured to be performed on a preceding vehicle in a preceding vehicle following system that performs follow control by non-mechanically connecting the preceding vehicle and a following vehicle, the vehicle control method comprising:
outputting an instruction for restricting a motion state of the preceding vehicle to the preceding vehicle based on information regarding an input vehicle performance of the following vehicle.

17. A preceding vehicle following system configured to perform follow control by non-mechanically connecting a preceding vehicle and a following vehicle,
wherein the preceding vehicle includes
an input portion configured to receive an input of information regarding a vehicle performance of the following vehicle,
an output portion configured to output an instruction for restricting a motion state of the preceding vehicle based on the information regarding the vehicle performance of the following vehicle that is input from the input portion to the output portion, and
an actuator configured to receive an input of the instruction for restricting the motion state of the preceding vehicle that is output from the output portion, and control braking, driving, or steering of the preceding vehicle.
